(19) United States
(12) Patent Application Publication
(10) Pub. No.: US 2024/0146887 A1
(43) Pub. Date: May 2, 2024

(54) METHOD OF OUTPUTTING PATTERN IMAGE, PROJECTOR, AND NON-TRANSITORY COMPUTER-READABLE STORAGE MEDIUM STORING PROGRAM

(71) Applicant: SEIKO EPSON CORPORATION, Tokyo (JP)

(72) Inventors: Shiki FURUI, Matsumoto-shi, Nagano-ken (JP); Takumi OIKE, Matsumoto-shi, Nagano-ken (JP)

(21) Appl. No.: 18/498,237

(22) Filed: Oct. 31, 2023

(30) Foreign Application Priority Data
Oct. 31, 2022 (JP) 2022-174475

(51) Int. Cl. H04N 9/31

(52) U.S. Cl. CPC H04N 9/3179; H04N 9/3147

(57) ABSTRACT

A method of outputting a pattern image includes outputting the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

The present application is based on, and claims priority from JP Application Serial Number 2022-174475, filed Oct. 31, 2022, the disclosure of which is hereby incorporated by reference herein in its entirety.

### BACKGROUND

### 1. Technical Field

The present disclosure relates to a method of outputting a pattern image, a projector, and a non-transitory computer-readable storage medium storing a program.

### 2. Related Art

In the past, there has been used a technology of making, for example, a projection image projected on a projection surface and a taken image obtained by taking the projection image correspond to each other by image processing using a phase shift method.

In the technology related to JP-A-2010-271580, an illumination control device first makes a projection device project a striped pattern in which luminance changes periodically in a first direction into a projection area. Further, the illumination control device obtains the taken image from a camera which has taken the projection image. The illumination control device makes the projection image and the taken image correspond to each other in the first direction using the phase shift method. Then, the illumination control device makes the projection device project a striped pattern in which the luminance changes periodically in a second direction perpendicular to the first direction into the projection area. Similarly, the illumination control device obtains the taken image from the camera which has taken the projection image. The illumination control device makes the projection image and the taken image correspond to each other in the second direction using the phase shift method.

However, in Document 1, the luminance continuously changes between pixels adjacent to each other in one pattern. Therefore, there occurs a confusion of a certain pixel and a pixel adjacent to that pixel in some cases due to an influence of a noise.

### SUMMARY

A method of outputting a pattern image according to an aspect of the present disclosure includes outputting the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

Further, a projector according to an aspect of the present disclosure includes an optical device, and at least one processor, wherein the at least one processor is configured to control the optical device to thereby project the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

Further, a non-transitory computer-readable storage medium storing a program according to another aspect of the present disclosure, the program making a computer execute processing including outputting the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

### BRIEF DESCRIPTION OF THE DRAWINGS

FIG. 1 is a block diagram showing a configuration of a projector 10 according to a first embodiment.

FIG. 2 is a diagram showing an example of a pattern image.

FIG. 3A through FIG. 3H are diagrams showing an example of the pattern images.

FIG. 4 is a flowchart showing an operation of the projector 10.

FIG. 5A through FIG. 5C are diagrams showing an example of the pattern images.

FIG. 6A through FIG. 6C are diagrams showing an example of the pattern images.

FIG. 7A through FIG. 7C are diagrams showing an example of the pattern images.

FIG. 8A through FIG. 8C are diagrams showing an example of the pattern images.

### DESCRIPTION OF EMBODIMENTS

A method of outputting a pattern image, a projector, and a program according to the embodiment will hereinafter be described with reference to the drawings. It should be noted that in each of the drawings, the size and the scale of each of the constituents are arbitrarily made different from actual ones. Further, although the embodiment described below is a preferable specific example, and is therefore provided with a variety of technically preferable limitations, the scope of the present disclosure is not limited to these aspects unless the description to limit the present disclosure is particularly presented in the following description.

### 1: First Embodiment

### 1-1: Configuration of Embodiment

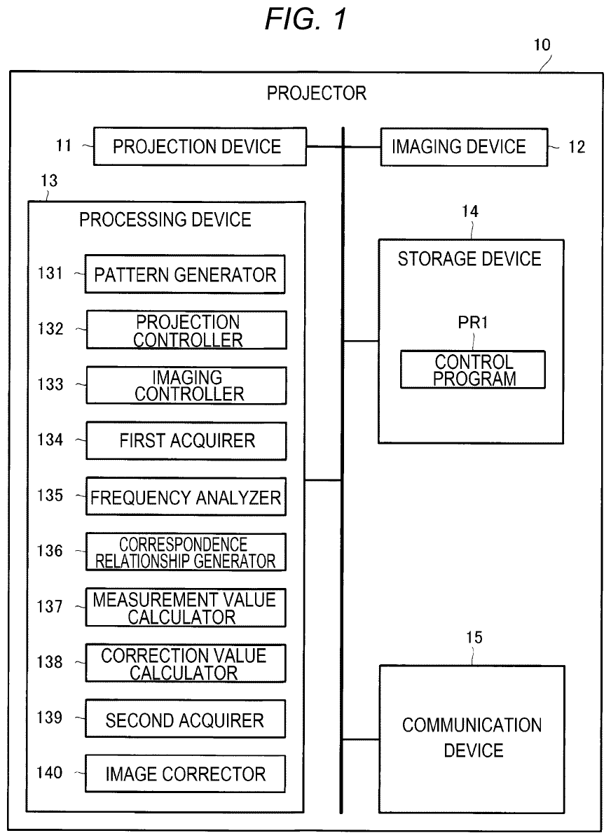

FIG. 1 is a block diagram showing a configuration of a projector 10 according to a first embodiment. The configuration of the projector 10 will hereinafter be described with reference to FIG. 1.

The projector 10 is provided with a projection device 11, an imaging device 12, a processing device 13, a storage device 14, and a communication device 15. The constituents of the projector 10 are coupled to each other with a single bus or a plurality of buses for communicating information. Further, the constituents of the projector 10 are each constituted by a single apparatus or a plurality of apparatuses, and some of the constituents of the projector 10 can be omitted. The projector 10 is an example of a “first projector.”

The projection device 11 is a device for projecting a projection image on a projection surface such as a screen or a wall. The projection device 11 includes, for example, a light source, a liquid crystal panel, and a projection lens, modulates light from the light source using the liquid crystal panel, and projects the light thus modulated on the projection surface such as the screen or the wall via the projection lens. In particular in the present embodiment, the projection device 11 projects a pattern image generated by a pattern generator 131 described later on the projection surface. The projection device 11 is an example of an “optical device.” It should be noted that in the above description, as the liquid crystal panel, it is possible to use a transmissive liquid crystal light valve, or it is also possible to use a reflective liquid crystal light valve. Further, it is possible to use a digital mirror device or the like for controlling the emission direction of the incident light for every micromirror as a pixel to thereby modulate the light emitted from the light source. Further, the configuration provided with the plurality of light modulation devices for the respective colored light beams is not a limitation, and it is also possible to adopt a configuration of modulating the plurality of colored light beams with a single light modulation device in a time-sharing manner.

The imaging device 12 takes a display image which is projected on the projection surface by the projection device 11 to thereby be displayed. Further, the imaging device 12 outputs the taken image thus taken to the processing device 13. In particular in the present embodiment, the imaging device 12 takes the pattern image projected by the projection device 11 on the projection surface, and outputs the pattern image thus taken to the processing device 13. The imaging device 12 can be a regular digital camera, or can also be an image sensor.

The processing device 13 is a processor for controlling the whole of the projector 10, and is constituted by, for example, a single chip or a plurality of chips. The processing device 13 is formed of a central processing device (CPU: Central Processing Unit) including, for example, an interface with peripheral devices, an arithmetic device, and registers. It should be noted that some or all of the functions of the processing device 13 can also be realized by hardware such as a DSP (Digital Signal Processor), an ASIC (Application Specific Integrated Circuit), a PLD (Programmable Logic Device), or an FPGA (Field Programmable Gate Array). The processing device 13 executes a variety of types of processing in parallel or in sequence. The processing device 13 is an example of a “computer.”

The storage device 14 is a recording medium which can be read by the processing device 13, and stores a plurality of programs including a control program PR1 to be executed by the processing device 13. It should be noted that the control program PR1 can be transmitted from another device for managing the projector 10 via a communication network not shown. The storage device 14 can be formed of at least one of, for example, a ROM (Read Only Memory), an EPROM (Erasable Programmable ROM), an EEPROM (Electrically Erasable Programmable ROM), and a RAM (Random. Access Memory). The storage device 14 can be called a register, a cache, a main memory, or a main storage device.

The communication device 15 is hardware as a transmitting/receiving device for performing communication with other devices. In particular in the present embodiment, the communication device 15 is also called, for example, a network device, a network controller, a network card, and a communication module.

The processing device 13 retrieves the control program PR1 from the storage device 14 and then executes the control program PR1 to thereby function as the pattern generator 131, a projection controller 132, an imaging controller 133, a first acquirer 134, a frequency analyzer 135, a correspondence relationship generator 136, a measurement value calculator 137, a correction value calculator 138, a second acquirer 139, and an image corrector 140.

The pattern generator 131 generates a pattern image to be used in the phase shift method. The details of the pattern image will hereinafter be described.

The number of times of performing the shift when executing the phase shift method according to the present embodiment is defined as N. Specifically, in the phase shift method according to the present embodiment, the projection device 11 sequentially projects the N pattern images. Further, the imaging device 12 takes the N pattern images sequentially projected. The processing device 13 performs the frequency analysis on a temporal change of the luminance in the N taken images to thereby obtain a phase value. Projecting the pattern image in the projection device 11 is an example of “outputting the pattern image.”

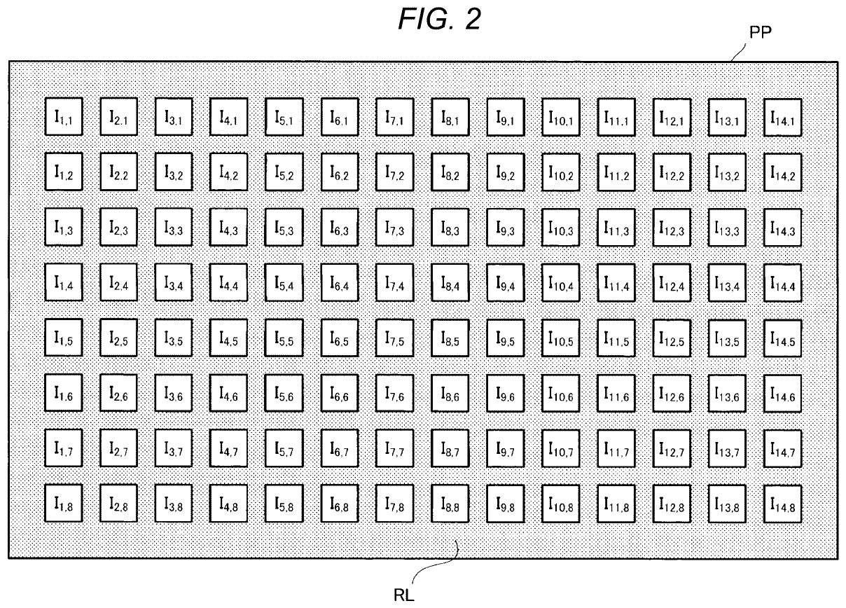

In the present specification, a coordinate system on the liquid crystal panel provided to the projection device 11 is called a “panel coordinate system.” In the liquid crystal panel provided to the projection device 11, positions of grid points obtained by dividing the liquid crystal panel in the horizontal direction into r equal parts and dividing the liquid crystal panel in the vertical direction into s equal parts are defined as luminance measurement positions. Further, areas each having a rectangular shape centering on the respective measurement positions are defined as I_{i,j} (1≤i≤r, 1≤j≤s). Each of the areas includes a plurality of pixels adjacent to each other. FIG. 2 is a diagram showing an example of the pattern image on the liquid crystal panel. In the pattern image PP, the areas I_{i,j} are arranged in a tiled manner in a state of being separated from each other. Here, I_{1,1} is an example of a “first area.” Further, I_{2,1} is an example of a “second area.” Further, in the pattern image PP, an area other than the areas I_{i,j} (1≤i≤r, 1≤j≤s), namely an area RL located between a certain area I_{i,j} and other areas I_{i,j} is an example of a “third area.” Similarly to the first area and the second area, the third area also includes a plurality of pixels adjacent to each other. It should be noted that in FIGS. 2, r=14 and s=8 are set, these are illustrative only, and the values of r and s are each an arbitrary integer no smaller than two. For example, it is possible to set r=14 and s=8 as shown in FIG. 2, or it is also possible to set r=19 and s=9.

Here, the pattern generator 131 assigns two phase values θᵢ, φⱼ to each of the areas I_{i,j}. Specifically, the phase values are respectively defined as θᵢ=2πxᵢ/W, φⱼ=2πyⱼ/H. Here, (xᵢ,yⱼ) is a coordinate of an i-th×j-th grid point in the panel coordinate system. W denotes horizontal resolution of the liquid crystal panel. H denotes vertical resolution of the liquid crystal panel. The horizontal resolution W of the liquid crystal panel is an example of a first period, and the vertical resolution H of the liquid crystal panel is an example of a second period.

In this case, the luminance of the area I_{i,j} in the pattern image projected n-th (n=0, 1, . . . , N−1) is determined by Formula (1) described below.

f(i,j,n)=cos(θᵢ+2πn/N)+cos(φⱼ+4πn/N) Formula (1)

In FIG. 2, the area I_{1,1} as the first area has first luminance based on at least (θᵢ+2πn/N) as a first phase in the first period. The area I_{2,1} as the second area has second luminance based on at least (θ₂+2πn/N) as a second phase in the first period unlike the first phase. Further, the first luminance is based on (φ₁+4πn/N) as a third phase in the second period different from the first period in addition to the first phase. On the other hand, the second luminance is based on (φ₂+4πn/N) as a fourth phase in the second period in addition to the second phase. Further, the area RL as the third area has third luminance based on a fifth phase different from both of the first phase and the second phase. The third luminance in the area RL can be constituted by a plain color such as black or white.

It should be noted that in practice, it is preferable to set a difference between the first phase and the second phase to an angle no smaller than, for example, 18° obtained by dividing 360° into 20 equal angles. Alternatively, it is preferable to set a difference between the first phase and the second phase to an angle no smaller than, for example, twice as large as an acceptable error.

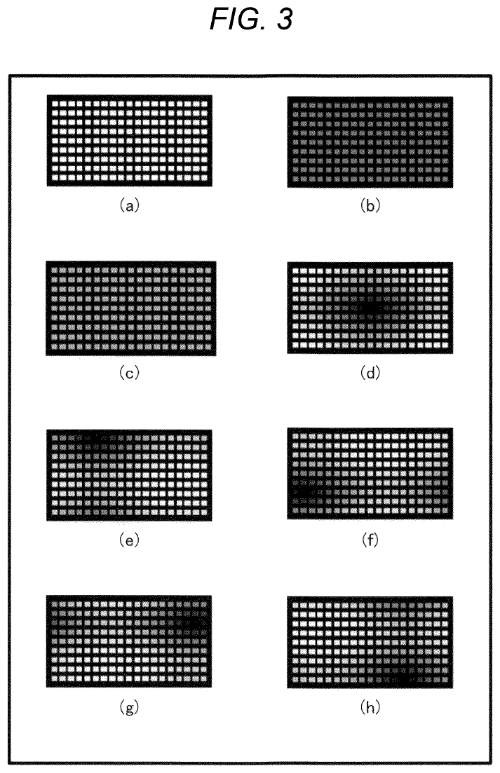

It should be noted that FIG. 3A through FIG. 3H are an example of the N=8 pattern images corresponding to Formula (1).

Unlike the standard phase shift method, in the present embodiment, the phase values θᵢ, φⱼ (1≤i≤r, 1≤j≤s) only take discontinuous values at predetermined intervals, namely discrete values. As a result, the allowable error range of the phase value to be detected is as extremely wide as described below as an example, and the erroneous detection of the phase value is difficult to occur.

(θᵢ₋₁+θᵢ)/2<θ<(θᵢ+θᵢ₊₁)/2

Further, since all of the pixels in the same area I_{i,j} has the same phase value, it is possible for the frequency analyzer 135 described later to perform smoothing in the spatial direction for removing the noise in the taken image of the pattern image. Therefore, it is easy for the frequency analyzer 135 to reduce the noise. Further, the frequency analyzer 135 described later is capable of detecting the phase value based only on the change in luminance of the pixels constituting the taken image of the pattern image. Therefore, the frequency analyzer 135 described later does not require a threshold value for distinguishing the colors, and the erroneous detection of the phase value also decreases.

In FIG. 1, the projection controller 132 makes the projection device 11 project the pattern image generated by the pattern generator 131 on the projection surface.

The imaging controller 133 makes the imaging device 12 take the pattern image projected on the projection surface.

The first acquirer 134 obtains the taken image, which is obtained by taking the pattern image, from the imaging device 12.

The frequency analyzer 135 performs the frequency analysis on the data representing the taken image obtained by the first acquirer 134.

In the present specification, the coordinate system in the taken image is referred to as a “camera coordinate system.” The frequency analyzer 135 performs the discrete Fourier transform on the temporal change in the luminance at the coordinate (X,Y) in the camera coordinate system of the N taken images obtained by taking the N pattern images sequentially projected. Specifically, the frequency analyzer 135 performs the discrete Fourier transform on the temporal change in the luminance at the coordinate (X,Y) in the taken image due to the sequential projection of the N pattern images. As a result, it is possible for the frequency analyzer 135 to calculate the phase values θᵢ, φⱼ (1≤i≤r, 1≤j≤s).

Specifically, the luminance values corresponding to the N taken images in the pixels at the coordinate (X,Y) in the camera coordinate system in the taken images of the pattern images are defined as a₀, a₁, . . . , a_{N-1}, respectively. Further, the values obtained by the frequency analyzer 135 performing the discrete Fourier transform on these N data are defined as b₀, b₁, . . . , b_{N-1}. Due to the nature of the Fourier transform, each of the values bₙ fulfills Formula (2) and Formula (3) described below.

b₁=b̅_̅{̅N̅-̅1̅}̅=λ(cos θ−i sin θ) Formula (2)

b₂=b̅_̅{̅N̅-̅2̅}̅=λ(cos ϕ−i sin ϕ) Formula (3)

It is possible for the frequency analyzer 135 to calculate the phase value θ and the phase value φ by applying the inverse trigonometric function to the values b₁, b₂ obtained by the Fourier transform. The frequency analyzer 135 obtains the values i and j which provide the most approximate values to these phase values θ and φ as described below.

θ≅θᵢ=2πxᵢ/W,ϕ≅ϕⱼ=2πyⱼ/H

The correspondence relationship generator 136 obtains the area I_{i,j} on the liquid crystal panel in the panel coordinate system corresponding to the coordinate (X,Y) in the camera coordinate system in the taken image based on the coordinate (X,Y) in the camera coordinate system in the taken image and the values i and j calculated by the frequency analyzer 135.

The measurement value calculator 137 calculates a variety of measurement values using the taken images obtained by the first acquirer 134 and the correspondence relationship between the camera coordinate system and the panel coordinate system generated by the correspondence relationship generator 136. The “taken image” mentioned here is not limited to the pattern image described above, but includes the taken image generated by the imaging device 12 taking the projection surface in, for example, a geometric correction, a color correction of the projection image, and a normal usage of the projector 10. Further, the “measurement value” mentioned here can be one or more of, for example, a three-dimensional shape of the projection surface, a parallax between the projection lens provided to the projection device 11 and the imaging device 12, and color unevenness on the liquid crystal panel.

The correction value calculator 138 calculates a variety of correction values based on the measurement values calculated by the measurement value calculator 137. The correction values are used in, for example, the geometric correction described above or the correction of the color unevenness of the projection image.

The second acquirer 139 obtains an image, which the user of the projector 10 views in the normal usage, from an external device via the communication device 15. The external device is constituted by an output device of a variety of images such as a personal computer or a tablet. The external device is provided with, for example, a DVD (Digital Versatile Disc) player.

The image corrector 140 sets the variety of correction values calculated by the correction value calculator 138 to the correction circuits to thereby correct the image obtained by the second acquirer 139. Further, the image corrector 140 outputs the corrected image to the projection controller 132. The projection controller 132 makes the projection device 11 project the image obtained from the image corrector 140 in the normal use.

### 1-2: Operation of Embodiment

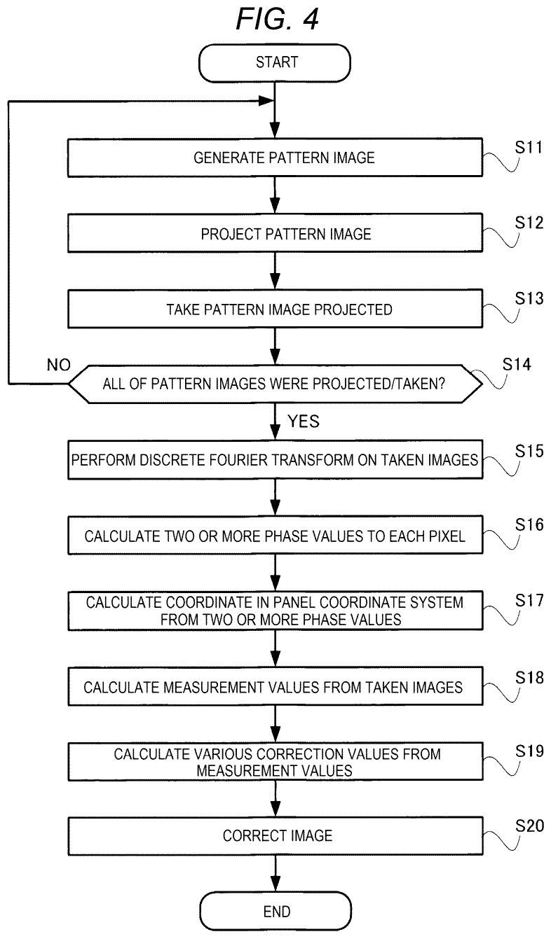

FIG. 4 is a flowchart showing the operation of the projector 10. The operation of the projector 10 will hereinafter be described with reference to FIG. 4.

In the step S11, the processing device 13 functions as the pattern generator 131. The processing device 13 generates a pattern image to be used in the phase shift method.

In the step S12, the processing device 13 functions as the projection controller 132. The processing device 13 makes the projection device 11 project the pattern image generated in the step S11 on the projection surface.

In the step S13, the processing device 13 functions as the imaging controller 133. The processing device 13 makes the imaging device 12 take the pattern image projected by the projection device 11 on the projection surface. Further, the processing device 13 functions as the first acquirer 134. The processing device 13 obtains the taken image, which is obtained by taking the pattern image, from the imaging device 12.

In the step S14, when the processing device 13 projects all of the pattern images and takes all of the pattern images (YES in S14), the processing device 13 executes the processing in the step S15. In the step S14, when the processing device 13 has not yet projected all of the pattern images and has not finished to take all of the pattern images (NO in S14), the processing device 13 executes the processing in the step S11.

In the step S15, the processing device 13 functions as the frequency analyzer 135. The processing device 13 performs the discrete Fourier transform in the time direction on the data representing the taken image obtained by the first acquirer 134.

In the step S16, the processing device 13 functions as the frequency analyzer 135. The processing device 13 calculates the values i and j corresponding to each pixel at the coordinate (X,Y) in the camera coordinate system based on the result of the discrete Fourier transform in the step S15.

In the step S17, the processing device 13 functions as the correspondence relationship generator 136. The processing device 13 generates the correspondence relationship between the coordinate values (X,Y) in the camera coordinate system and the areas I_{i,j} on the liquid crystal panel in the panel coordinate system.

In the step S18, the processing device 13 functions as the measurement value calculator 137. The processing device 13 calculates the variety of measurement values using the taken images obtained by the first acquirer 134, and the correspondence relationship generated in the step S17.

In the step S19, the processing device 13 functions as the correction value calculator 138. The processing device 13 calculates the variety of correction values based on the measurement values calculated in the step S18.

In the step S20, the processing device 13 functions as the image corrector 140. The processing device 13 sets the variety of correction values calculated in the step S19 to the correction circuits to thereby correct the image obtained from the external device.

### 2: Modified Examples

The present disclosure is not limited to the embodiment hereinabove illustrated. Specific aspects of modifications will hereinafter be illustrated.

### 2-1: Modified Example 1

In the embodiment described above, the pattern generator 131 assigns the two phase values θᵢ, φⱼ to each of the areas I_{i,j}. However, the number of the phase values to be assigned to each of the areas is not limited to two. For example, in the embodiment described above, the pattern generator 131 divides the liquid crystal panel into the r equal parts in the horizontal direction, and divides the liquid crystal panel into the s equal parts in the vertical direction, and defines the j-th×i-th area as the area I_{i,j} in that liquid crystal panel. In other words, the pattern generator 131 identifies the areas I_{i,j} using the two index values of i and j. However, it is possible for the pattern generator 131 to identify areas in the liquid crystal panel as the areas Iᵢ using one index value i alone. Further, it is possible for the pattern generator 131 to assign a single phase value θᵢ to each of the areas Iᵢ. In this case, the pattern generator 131 defines the phase values θ₁, θ₂, . . . , θᵣ which are assigned one-to-one to the respective areas I₁, I₂, . . . , Iᵣ, and which are different from each other, as follows.

θᵢ=2πi/r

Further, the luminance of the area Iᵢ in the pattern image projected n-th (n=0, 1, . . . , N−1) is determined by Formula (4) described below.

f(i,n)=cos(θᵢ+2πn/N) Formula (4)

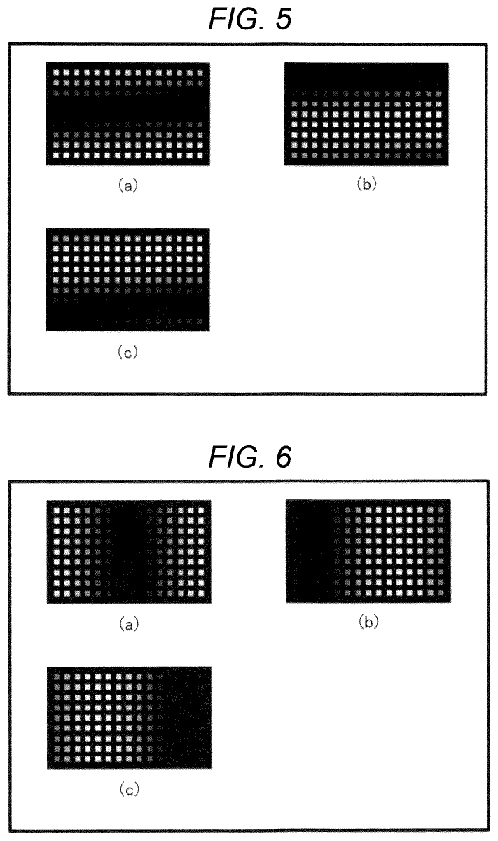

It should be noted that FIG. 5A through FIG. 5C are an example of the N=3 pattern images corresponding to Formula (4).

### 2-2: Modified Example 2

Alternatively, it is possible for the pattern generator 131 to individually detect the phase value related to the x direction and the phase value related to the y direction similarly to the standard shift method. In order to detect the phase value related to the x direction, the luminance of the area I_{i,j} in the pattern image projected n-th (n=0, 1, . . . , N−1) is determined by Formula (5) described below.

fₓ(i,n)=cos(θᵢ+2πn/N) Formula (5)

Meanwhile, in order to detect the phase value related to the y direction, the luminance of the area I_{i,j} in the pattern image projected n-th (n=0, 1, . . . , N−1) is determined by Formula (6) described below.

f_{y}(j,n)=cos(φⱼ+2πn/N) Formula (6)

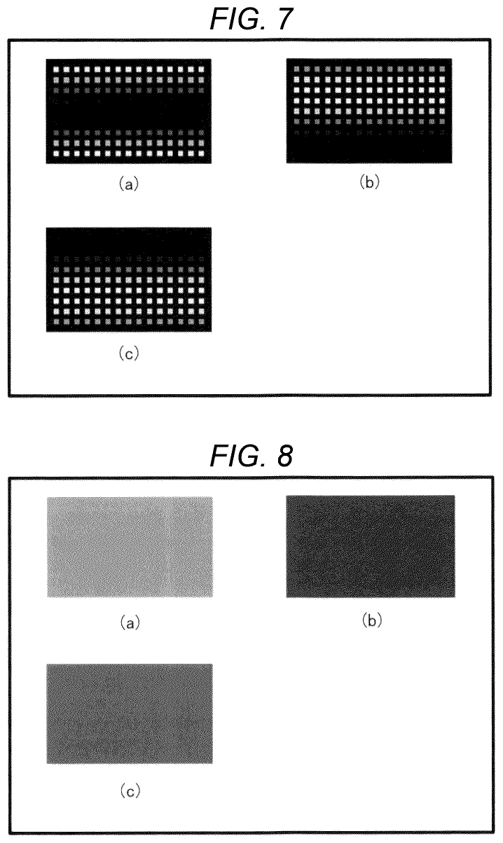

It should be noted that FIG. 6A through FIG. 6C are an example of the N=3 pattern images corresponding to Formula (5). FIG. 7A through FIG. 7C are an example of the N=3 pattern images corresponding to Formula (6).

### 2-3: Modified Example 3

In the embodiment described above, the single projector 10 projects the N pattern images PP, and at the same time, the pattern images PP each include the r×s rectangular areas I_{i,j} (1≤i≤r, 1≤j≤s). However, when a plurality of the projectors 10 exists, it is possible to identify the projection range of each of the projectors 10 in the camera coordinate system in the taken image by each of the plurality of projectors 10 projecting the single area I_{i,j}.

Specifically, in Modified Example 3, the number of the projectors 10 is denoted by K, and the phase value to be assigned to the k-th (k=0, 1, . . . , K−1) projector 10 is defined as θₖ=2πk/K.

When the number of the patterns thus imaged is denoted by N, the luminance of the pattern image projected n-th (n=0, 1, . . . , N−1) is determined by Formula (7) described below.

f(n)=cos(θₖ+2πn/N) Formula (7)

Similarly to the embodiment described above, the projection device 11 sequentially projects these N pattern images. Further, the imaging device 12 takes the N pattern images sequentially projected. The processing device 13 performs the frequency analysis on the temporal change of the luminance in the N taken images to thereby obtain the phase value θ. Further, the processing device 13 derives the k-th projector 10 which images the pixel at the coordinate (X,Y) based on θₖ closest to the phase value θ thus obtained at the coordinate (X,Y) in the camera coordinate system in the taken image. It should be noted that FIG. 8A through FIG. 8C are an example of the N=3 pattern images corresponding to Formula (7).

In Modified Example 3, when defining a 1-st (k=1) projector 10 as a “first projector,” and a 2-nd (k=2) projector 10 as a “second projector,” the first projector projects, for example, a first pattern image corresponding to the first area I_{1,1}. Further, the second projector projects, for example, a second pattern image corresponding to the second area I_{2,1}.

### 2-4: Modified Example 4

In the embodiment described above, the functions provided to the processing device 13 provided to the projector 10 can be realized by an external device of the projector 10. The processing device 13 as the external device of the projector 10 is, for example, a personal computer or a tablet. For example, it is possible to adopt a configuration in which the external device performs a function corresponding to the pattern generator 131 out of the functional blocks provided to the processing device 13, the pattern images generated by the external device are transmitted to the projector 10, and the projector 10 obtains the pattern images transmitted from the external device. Further, the functions provided to the processing device 13 provided to the projector 10 can be realized as applications which can be distributed via a communication network not shown. The external device is an example of a “computer.” Transmitting the pattern image generated by the external device to the projector 10 is an example of “outputting the pattern image.”

### 2-5: Modified Example 5

In the embodiment described above, the pattern generator 131 generates the pattern images, but it is possible for the processing device 13 to obtain the pattern images stored in the storage device 14 instead of being provided with the pattern generator 131.

### 2-6: Modified Example 6

In the embodiment described above, the projector 10 incorporates the imaging device 12, but the imaging device 12 can be an external device of the projector 10. The imaging device 12 as the external device of the projector 10 can be coupled to the projector 10 so as to be able to communicate with each other via an interface such as a USB interface.

### 3: Conclusion of Present Disclosure

Hereinafter, the conclusion of the present disclosure will supplementarily be noted.

### Supplementary Note 1

A method of outputting a pattern image including outputting the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

According to the method of outputting the pattern image described above, the erroneous detection of the phase value due to an influence of the noise, and by extension, the confusion of a certain pixel and a pixel adjacent to that pixel are prevented. Specifically, in the pattern image described above, the pixels in the same area have the same phase value. Therefore, it is possible for the projector to perform smoothing of the space for the noise removal in the taken image. Therefore, it is possible to make the projector difficult to be affected by the noise when executing the phase shift method.

### Supplementary Note 2

The method of outputting the pattern image described in Supplementary Note 1, wherein the first luminance is based on a third phase in a second period different from the first period in addition to the first phase, and the second luminance is based on a fourth phase in the second period in addition to the second phase.

According to the method of outputting the pattern image described above, the first luminance is based on the first phase and the third phase. Further, the second luminance is based on the second phase and the fourth phase. Therefore, it is possible for the projector to measure the phase value related to the x direction and the phase value related to the y direction with a single execution of the phase shift method.

### Supplementary Note 3

The method of outputting the pattern image according to one of Supplementary Note 1 and Supplementary Note 2, wherein the outputting the pattern image includes projecting the pattern image using a first projector.

According to the method of outputting the pattern image described above, it is possible for the projector to reduce the influence of the noise when executing the phase shift method using the single projector 10.

### Supplementary Note 4

The method of outputting the pattern image according to one of Supplementary Note 1 and Supplementary Note 2, wherein the pattern image includes a first pattern image corresponding to the first area and a second pattern image corresponding to the second area, and the outputting the pattern image includes projecting the first pattern image using a first projector, and projecting the second pattern image using a second projector.

According to the method of outputting the pattern image described above, the first projector projects the first pattern image, and the second projector projects the second pattern image. Therefore, when the projection is performed by a plurality of the projectors, it is possible for the projector 10 to identify the projection ranges of the respective projectors on the projection surface.

### Supplementary Note 5

The method of outputting the pattern image according to any one of Supplementary Note 1 through Supplementary Note 4, wherein the first phase and the second phase are different at least 18 degrees from each other.

According to the method of outputting the pattern image described above, the first phase and the second phase are different at least 18 degrees from each other. Therefore, when the projector executes the phase shift method, since the phase values corresponding to the respective areas take discontinuous values at predetermined intervals, the allowable range of the error increases, and it is possible to reduce the erroneous detection.

### Supplementary Note 6

The method of outputting the pattern image according to any one of Supplementary Note 1 through Supplementary Note 5, wherein the first area and the second area are separated from each other.

According to the method of outputting the pattern image described above, when the projector executes the phase shift method, since the areas are separated from each other, the allowable range of the error increases, and it is possible to reduce the erroneous detection.

### Supplementary Note 7

The method of outputting the pattern image according to any one of Supplementary Note 1 through Supplementary Note 6, wherein the pattern image further includes a third area different from the first area and the second area between the first area and the second area, the third area having third luminance based on a fifth phase different from both of the first phase and the second phase, and including a plurality of pixels adjacent to each other.

According to the method of outputting the pattern image described above, when the projector executes the phase shift method, since the third area is located between the first area and the second area, the allowable range of the error increases, and it is possible to reduce the erroneous detection.

### Supplementary Note 8

A projector including an optical device, and at least one processor, wherein the at least one processor is configured to control the optical device to thereby project the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

According to the projector described above, the erroneous detection of the phase value due to an influence of the noise, and by extension, the confusion of a certain pixel and a pixel adjacent to that pixel are prevented. Specifically, in the pattern image described above, the pixels in the same area have the same phase value. Therefore, it is possible for the projector to perform smoothing of the space for the noise removal in the taken image. Therefore, it is possible to make the projector difficult to be affected by the noise when executing the phase shift method.

### Supplementary Note 9

A non-transitory computer-readable storage medium storing a program configured to make a computer execute processing including outputting the pattern image which is used in a phase shift method, and which includes a first area having first luminance based on at least a first phase in a first period, and including a plurality of pixels adjacent to each other, and a second area different from the first area, having second luminance based on at least a second phase in the first period different from the first phase, and including a plurality of pixels adjacent to each other.

According to the program described above, the erroneous detection of the phase value due to an influence of the noise, and by extension, the confusion of a certain pixel and a pixel adjacent to that pixel are prevented. Specifically, in the pattern image described above, the pixels in the same area have the same phase value. Therefore, it is possible for the projector to perform smoothing of the space for the noise removal in the taken image. Therefore, it is possible to make the projector difficult to be affected by the noise when executing the phase shift method.

What is claimed is:

1. A method of outputting a pattern image, the method comprising:
outputting the pattern image which is used in a phase shift method, and which includes
a first area having first luminance based on at least a first phase in a first period, and including a plurality of pixels adjacent to each other, and
a second area different from the first area, having second luminance based on at least a second phase in the first period different from the first phase, and including a plurality of pixels adjacent to each other.

2. The method of outputting the pattern image according to claim 1, wherein
the first luminance is based on a third phase in a second period different from the first period in addition to the first phase, and
the second luminance is based on a fourth phase in the second period in addition to the second phase.

3. The method of outputting the pattern image according to claim 1, wherein
the outputting the pattern image includes projecting the pattern image using a first projector.

4. The method of outputting the pattern image according to claim 1, wherein
the pattern image includes a first pattern image corresponding to the first area and a second pattern image corresponding to the second area, and
the outputting the pattern image includes
projecting the first pattern image using a first projector, and
projecting the second pattern image using a second projector.

5. The method of outputting the pattern image according to claim 1, wherein
the first phase and the second phase are different at least 18 degrees from each other.

6. The method of outputting the pattern image according to claim 1, wherein
the first area and the second area are separated from each other.

7. The method of outputting the pattern image according to claim 1, wherein
the pattern image further includes a third area different from the first area and the second area between the first area and the second area, the third area having third luminance based on a fifth phase different from both of the first phase and the second phase, and including a plurality of pixels adjacent to each other.

8. A projector comprising:
an optical device; and
at least one processor, wherein
the at least one processor is configured to control the optical device to thereby project the pattern image which is used in a phase shift method, and which includes
a first area having first luminance based on at least a first phase in a first period, and including a plurality of pixels adjacent to each other, and
a second area different from the first area, having second luminance based on at least a second phase in the first period different from the first phase, and including a plurality of pixels adjacent to each other.

9. A non-transitory computer-readable storage medium storing a program configured to make a computer execute processing comprising:
outputting the pattern image which is used in a phase shift method, and which includes
a first area having first luminance based on at least a first phase in a first period, and including a plurality of pixels adjacent to each other, and
a second area different from the first area, having second luminance based on at least a second phase in the first period different from the first phase, and including a plurality of pixels adjacent to each other.
